(19) United States
(12) Patent Application Publication
(10) Pub. No.: US 2019/0016994 A1
(43) Pub. Date: Jan. 17, 2019

(54) SOAP FORMULATIONS WITH POLYSACCHARIDE

(71) Applicant: The Board of Trustees of the University of Alabama, Tuscaloosa, AL (US)

(72) Inventors: Daniel T. Daly, Tuscaloosa, AL (US); Rachel M. Frazier, Tuscaloosa, AL (US); Scott K. Spear, Bankston, AL (US); Ying Qin, Tuscaloosa, AL (US)

(21) Appl. No.: 16/037,335

(22) Filed: Jul. 17, 2018

Related U.S. Application Data
(60) Provisional application No. 62/533,379, filed on Jul. 17, 2017.

(51) Int. Cl. C11D 3/22; C11D 3/20; C11D 3/37; C11D 17/00

(52) U.S. Cl. CPC C11D 3/222; C11D 3/2079; C11D 3/3761; C11D 3/3769; C11D 17/0047; C11D 3/3707; C11D 3/3723; C11D 3/3715; C11D 3/3753

(57) ABSTRACT

Soap compositions including a polymer matrix comprising a first polymer, a polysaccharide that is substantially homogenously distributed within the polymer matrix, and a fatty acid are disclosed.

### CROSS REFERENCE TO RELATED APPLICATIONS

This application claims the benefit of priority to U.S. Provisional Application No. 62/533,379 filed Jul. 17, 2017, the disclosure of which is incorporated herein by reference in its entirety.

### FIELD The present disclosure relates generally to soap formulations, particularly to soap formulations comprising a polysaccharide.

### BACKGROUND

Proper hygiene aides in preventing the transmission of bacteria, viruses, soils, and other contaminants. Frequent use of hand soaps, shampoos, body washes, facial cleansers, shave foams, makeup removers, and the like help to maintain personal hygiene. Conventional product forms for personal cleansing include, among others, bars, liquids, gels, foams, and powders.

However, conventional products may have various disadvantages. For example, bar soaps are inconvenient for travel because they must be dried or stored in a portable case. Aerosols are restricted from airplanes, and liquid soap containers are cumbersome and can leak. Further, liquids are subject to postal restrictions. Additionally, conventional liquid soaps have limited shelf-lives, which begin at the time of production and can expire long before a consumer uses the product. Further, abrasive cleaners have become a substantial environmental concern due to water pollution by microplastics such as microbeads. As a consequence, the use of microbeads in soaps, toothpastes, and body washes has been banned in the United States.

Based on the foregoing, there exists a need for a soap product that is lightweight, can dispense a metered amount of a personal cleansing product, is not susceptible to leakage during travel or shipment, is not limited by shelf-life, and is environmentally safe. The soap compositions and methods disclosed herein address these and other needs.

### SUMMARY

Disclosed herein are soap compositions. The soap compositions can include a polymer matrix comprising a first polymer, a polysaccharide that is substantially homogenously distributed within the polymer matrix, and a fatty acid. The first polymer and the polysaccharide can be miscible. The soap compositions can be in the form of a dry, solid, soap sheet. The soap sheet can be prepared so that it can be conveniently and quickly soften, melt, or at least partially dissolve in the palm of a consumer to reconstitute a liquid product for ease of application. The soap compositions described herein may soften at a temperature of 35° C. or greater, such as from 35° C. to 70° C.

The first polymer in the polymer matrix can be selected from a polyalkylene oxide, a polyamine, a polyimine, a polyalcohol, a polyvinyl acetate, a polycarboxylic acid, a polyanhydride, cellulose, a blend thereof, or a copolymer thereof. Specific examples of polymers suitable for use in the polymer matrix include a polyvinyl amine, a polyetheramine, a polyoxyalkylene amine, a polyalkyleneimine, a polyethylene oxide, a polypropylene oxide, a polyvinyl alcohol, a polyethylene-vinyl acetate copolymer, a polyethylene-vinyl alcohol copolymer, a polylactic acid, a polylactic acid-glycolic acid copolymer, a polylactic acid-succinic acid copolymer, a blend thereof, or a copolymer thereof.

In some aspects, the first polymer in the polymer matrix is crosslinked with a linker. The linker, prior to crosslinking the first polymer, can comprise an aldehyde, an epoxide, a ketone, an ether, an ester, an isocyanate, an amine, an amino acid, a hydroxyl, a substituted or unsubstituted alkyl, a substituted or unsubstituted alkenyl, a substituted or unsubstituted alkynyl, an alkoxy, or a combination thereof. In some examples, the linker, prior to crosslinking the first polymer, can comprise a dialdehyde, formaldehyde, a paraformaldehyde, glycidol, epichlorohydrin, a dione, a diisocyanate, an ether amine, an amino aldehyde, an amino ester, a hydroxy aldehyde, a hydroxy ester, or a combination thereof.

The polymer matrix can be present in an amount of from 25% to 90% by weight, based on the total weight of the soap composition. For example, the polymer matrix can be present in an amount of from 50% to 90% or from 65% to 85% by weight, based on the total weight of the soap composition.

As described herein, the soap composition can include a polysaccharide that is substantially homogenously distributed within the polymer matrix. The polysaccharide can comprise chitin, chitosan, cellulose, or a combination thereof. The polysaccharide can be present in an amount of from 1% to 35%, such as from 10% to 25% by weight, based on the total weight of the soap composition.

The fatty acid in the soap composition can be a C₈-C₂₂ fatty acid. Suitable examples of fatty acids for use in the soap composition can include lauric acid, palmitic acid, palmitoleic acid, stearic acid, oleic acid, linoleic acid, myristic acid, or a mixture thereof. The fatty acid can be present in an amount of from 1% to 10% by weight, based on the total weight of the soap composition.

In some aspects, the fatty acid can be covalently linked directly or indirectly to the polymer matrix and/or the polysaccharide. For instance, the fatty acid can be covalently linked indirectly to the polymer matrix and/or the polysaccharide via a linker.

The soap compositions described herein can further comprise a surfactant. The surfactant can include an anionic surfactant, a cationic surfactant, an amphoteric surfactant, a nonionic surfactant, or a combination thereof. Examples of suitable surfactants include sodium dodecylbenzenesulfonate, deoxycholic acid, or combinations thereof.

Exemplary soap compositions disclosed herein can include a surfactant in an amount from 30% to 60% by weight, based on the total weight of the soap composition, a polysaccharide in an amount from 1% to 35% by weight, based on the total weight of the soap composition, a fatty acid in an amount from 1% to 10% by weight, based on the total weight of the soap composition, and a polymer matrix in an amount from 25% to 50% by weight, based on the total weight of the soap composition.

The soap compositions can further comprise a fragrance. The fragrance can be in an amount from 0.1% to 2% by weight, based on the total weight of the soap composition.

Methods of preparing the soap compositions are also disclosed. The method can include blending the polymer matrix, the polysaccharide, and the fatty acid to form a substantially homogenous mixture. The mixture, in some embodiments, does not include a solvent. The method of preparing the soap compositions can include reacting a linker (when present) with the polymer matrix, the polysaccharide, and/or the fatty acid prior or during blending.

The methods of preparing the soap compositions can include heating the soap mixture at or above the melting temperature of the lowest melting polymer in the mixture. In some aspects, the method can comprise heating the soap mixture at or above the melting temperature of the polymer matrix. In some examples, the method can comprise heating the soap mixture at a temperature of 150° C. or less.

### BRIEF DESCRIPTION OF THE FIGURES

The accompanying figures, which are incorporated in and constitute a part of this specification, illustrate several aspects described below.

FIG. 1 are images of soap compositions described herein.

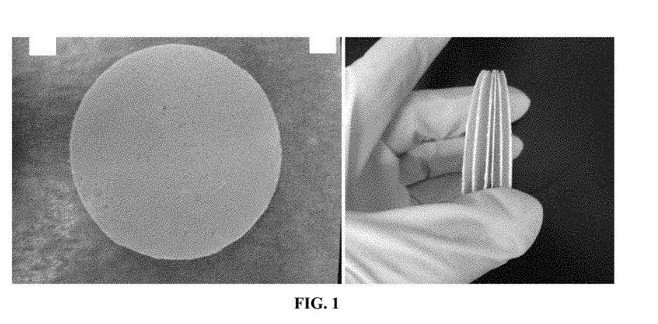

### DETAILED DESCRIPTION

### General Definitions

The materials, compositions, articles, and methods described herein may be understood more readily by reference to the following detailed description of specific aspects of the disclosed subject matter and the Examples included therein and to the Figures.

Before the present materials, compositions, articles, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such component, and the like.

“Optional” or “optionally” means that the subsequently described event or circumstance can or cannot occur, and that the description includes instances where the event or circumstance occurs and instances where it does not. For example, the phrase “L is an optional linker” means that L may or may not be present in the composition and that the description includes both compositions where L is present (e.g., linking a first active substance to a second active substance) and compositions where L is not present, in which case the first and second active substances are directly bonded together.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed, then “less than or equal to 10” as well as “greater than or equal to 10” is also disclosed. It is also understood that throughout the application data are provided in a number of different formats and that this data represent endpoints and starting points and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

Reference will now be made in detail to specific aspects of the disclosed materials, compounds, compositions, articles, and methods, examples of which are illustrated in the accompanying Examples and Figures.

### Materials and Compositions

Disclosed herein are soap compositions that comprise a polymer matrix, a polysaccharide that is substantially homogeneously distributed within the polymer matrix, and a fatty acid. In disclosed examples, the soap compositions can include a linker bonded to the polymer matrix, the polysaccharide, and/or the fatty acid. In these examples, the fatty acid can be attached to or associated with the polymer matrix and/or the polysaccharide.

The soap compositions can be produced in any of a variety of product forms, including a sheet or pad that can be used alone or in combination with other personal care components (e.g., water). The soap sheet or pad may be of an adequate size for ease of handling by the user. In some embodiments, the soap sheet or pad may have a square shape, a rectangle shape, a disc shape or any other suitable shape.

Polymer Matrix

As described herein, the soap compositions can include a polymer matrix. The polymer matrix can include any polymer (also referred to herein as a first polymer) that can disperse, distribute, or act as a solvent for the polysaccharide within the matrix. The polymer matrix in the soap compositions can function as a structural component for the soap compositions. The polymer matrix can include a polymer that softens or melts at low temperatures, such as 150° C. or less. In some embodiments, the polymer matrix can include a polymer that softens or melts at a temperature of 140° C. or less, 130° C. or less, 125° C. or less, 120° C. or less, 110° C. or less, 100° C. or less, 95° C. or less, 90° C. or less, 85° C. or less, from 70° C. to 135° C., from 70° C. to 120° C., from 70° C. to 110° C., or from 75° C. to 100° C.

The polymer matrix can include a polymer that is water-soluble polymer. As used herein, the term “water-soluble polymer” is broad enough to include both water-soluble and water-dispersible polymers, and refers to a polymer with a solubility in water, measured at 25° C., of at least about 0.1 gram/liter (g/L). In some embodiments, the polymer matrix can have solubility in water, measured at 25° C., of from about 0.1 gram/liter (g/L) to about 500 grams/liter (g/L). (This indicates production of a macroscopically isotropic or transparent, colored or colorless solution). The polymers for making these solids may be of synthetic or natural origin and may be modified by means of chemical reactions. They may or may not be film-forming. These polymers should be physiologically acceptable, i.e., they should be compatible with the skin, mucous membranes, the hair and the scalp.

The polymer in the polymer matrix can be selected such that their weighted average molecular weight is 500,000 Da or less. In some embodiments, the polymer in the polymer matrix can have a weighted average molecular weight 400,000 Da or less, 300,000 Da or less, 200,000 Da or less, 100,000 Da or less, 90,000 Da or less, 80,000 Da or less, 70,000 Da or less, 60,000 Da or less, 50,000 Da or less, 45,000 Da or less, 40,000 Da or less, 35,000 Da or less, 30,000 Da or less, 25,000 Da or less, 20,000 Da or less, 15,000 Da or less, or 10,000 Da or less,. In some embodiments, the polymer in the polymer matrix can have a weighted average molecular weight from 1,000 to 50,000, from 1,000 to 40,000, from 5,000 to 50,000, from 1,000 to 25,000, from 1,000 to 20,000, from 1,000 to 15,000, from 1,000 to 10,000, or from 1,500 to 10,000,. The weighted average molecular weight is computed by summing the average molecular weights of each polymer raw material multiplied by their respective relative weight percentages by weight of the total weight of polymers present within the porous solid.

In some aspects, the polymer matrix can include a functional group that can be coupled (e.g., bonded or attached) to a linker, examples of which are described herein. In some examples, the polymer matrix can include a polymer comprising one or more electrophilic functional groups. By “electrophilic functional group” is meant any moiety that contains or can be made to contain an electron deficient atom; examples of electrophilic functional groups are also disclosed herein. Alternatively, the polymer matrix can include a polymer comprising one or more nucleophilic functional groups. By “nucleophilic functional group” is meant any moiety that contains or can be made to contain an electron rich atom; examples of nucleophilic functional groups are disclosed herein.

Nucleophilic Functional Groups

In some embodiments, the polymer matrix can include a polymer that comprises one or more nucleophilic functional groups, which can react with an electrophilic group on the linker, the polysaccharide or the fatty acid to form a bond. It is understood that when the nucleophilic functional group is reacted with an electrophilic functional group, the nucleophilic functional group may no longer be nucleophilic. In this sense, the disclosed polymer can, in some examples, be without a nucleophilic functional group; that is, the nucleophilic functional group has been coupled to an electrophilic functional group on the linker and is no longer nucleophilic or as nucleophilic as before. However, for the purposes of this disclosure, various functional groups are identified by referring to them prior to bond formation. For example, in a compositions disclosed herein the polymer can be referred to as having an amine and a linker can be referred to as having an aldehyde, even though in the disclosed compositions, the amine functional group of the polymer is not present due to having formed a bond with the aldehyde functional group of the linker to result in an imine. This practice is used throughout when referring to the components of the soap compositions disclosed herein.

Examples of nucleophilic functional groups that can be present on the polymer include an amine, an amide, a hydroxyl group, or a combination thereof.

In some examples, the polymer matrix can include a polymeric amine (i.e., a polymer that comprises one or more amine groups). In this instance, the amine may act as a nucleophilic functional group that can react with an electrophilic moiety (e.g., reacting with an aldehyde or ester to form an imine or amide bond, respectively).

In some examples, the polymeric amines can be derived from olefin based polymers that contain one or more amine functional group. Many such polyamines can be obtained commercially or can be prepared by methods known in the art. Suitable examples of polyamines that can used as a polymer in the polymer matrix include, but are not limited to, polyvinyl amine, polyetheramine, and polyalkyleneimines such as polyethyleneimine.

Still further examples of polymeric amines are polyamides that are prepared by the condensation of a diamine monomer with a diacid or diester monomer. Such polyamides are well known in the art and can be obtained commercially. Alternatively, polyamides can be prepared by self-condensation of a monomer containing an amine and an acid or ester functional group, or through a ring opening reaction of a cyclic amide (i.e., lactam) such as caprolactam. Nylons are common examples of such polyamides.

Yet another example of a suitable polymeric amine is a polyether amine. Polyether amines contain primary amino groups attached to the terminus of a polyether backbone. The polyether backbone can be based either on propylene oxide (PO), ethylene oxide (EO), or mixed EO/PO/BO. In some aspects, the polyether amine can be a polyoxyalkyleneamine. Such polyether amines can be obtained commercially from Huntsman Performance Products (Salt Lake City, Utah) under the name JEFFAMINE (e.g., JEFFAMINE D230). JEFFAMINES can have monoamines, diamines, and triamines, and are available in a variety of molecular weights, ranging up to 5,000.

A still further example of a suitable polymeric amine is a dendrimeric polyamine. Such dendrimers, in one example, have a macromolecular architecture called “dense star” polymers. Unlike classical polymers, these dendrimers have a high degree of molecular uniformity, narrow molecular weight distribution, specific size, and shape characteristics, and a highly-functionalized terminal surface.

An example of dendrimeric polyamines are the PAMAM™ dendrimers, which are poly(amidoamine) dendrimers. The manufacturing process for these dendrimers is a series of repetitive steps starting with a central initiator core (e.g., ethylenediamine-cores). Each subsequent growth step represents a new “generation” of polymer with a larger molecular diameter, twice the number of reactive surface sites, and approximately double the molecular weight of the preceding generation. Suitable PAMAM™ dendrimers are commercially available such as from Sigma Aldrich (Milwaukee, Wis.). Further, PAMAM™ dendrimers can be coupled with 1,3-phenylene diisocyanate.

Another suitable example of a polymer in the polymer matrix can be a polymeric alcohol (i.e., a polymer that comprises one or more hydroxyl groups). Such hydroxyl groups can react with electrophilic groups to form a bond (e.g., react with a halogen, aldehyde, epoxides, an acid, or ester). A suitable polymeric alcohol is polyvinyl alcohol, which is commercially available or can be prepared by the hydrolysis of polyvinyl acetate. Other suitable polymeric alcohols include, but are not limited to, 1,1,1-tris(hydroxymethyl)propane (TMP), diglycerol, hyperbranched polyglycerol, saccharides, and polysaccharides. It is also contemplated that the polymeric alcohols can be coupled with 1,3-phenylene-diisocyanate to form a large cross-linked complex to reduce or prevent leaching.

Electrophilic Functional Groups

In another aspect of the disclosed polymer matrix, the polymer can be a polymeric compound that comprises one or more electrophilic functional groups that can react with a nucleophilic group to form a bond. Examples of suitable polymers can include ester, aldehyde, ether, ketal, enal, anhydride, and halogen groups. One or more different electrophilic groups can be present on the polymer in the polymer matrix.

In some examples, the polymer in the polymer matrix can include a polyacid (i.e., a polymer that comprises one or more acid groups). Polyacids are well known and can be obtained commercially or by methods known in the art, for example, polymaleic acid.

The polymer in the polymer matrix can include a cellulose containing material. The cellulose material can be a regenerated cellulose. The cellulose containing material can include cellulose derivatives such as hydroxypropylmethylcellulose, hydroxymethylcellulose, hydroxyethylcellulose, methylcellulose, hydroxypropylcellulose, ethylcellulose, carboxymethylcellulose, cellulose acetate phthalate, nitrocellulose and other cellulose ethers/esters; and guar derivatives such as hydroxypropyl guar. Suitable methods for preparing regenerated cellulose are described in U.S. Pat. No. 8,883,193, the disclosure of which is incorporated herein in its entirety. The starting cellulose can be any cellulosic material. Examples of suitable starting cellulose include, but are not limited to, fibrous cellulose, wood pulp, paper, linters, cotton, and the like, including mixtures thereof. This produces regenerated cellulose, which, in many cases, has substantially the same molecular weight as the starting cellulose from which it was prepared.

In disclosed embodiments of the polymer matrix, the polymer can be selected from a polyalkylene oxide, a polyamine, a polyimide, a polyvinyl alcohol, a polyvinyl acetate, a polycarboxylic acid, a polyanhydride, cellulose, a blend thereof, or a copolymer thereof. In specific examples, the polymer can include a polyvinyl amine, polyetheramine, polyoxyalkylene amine, polyalkyleneimide, polyethylene oxide, polypropylene oxide, polyvinyl alcohol, polyethylene-vinyl acetate copolymer, polyethylene-vinyl alcohol copolymer, polylactic acid, polylactic acid-glycolic acid copolymer, polylactic acid-succinic acid copolymer, a blend thereof, or a copolymer thereof. In some examples, the polymer can be selected from polyethylene oxide, polypropylene oxide, a blend thereof, or a copolymer thereof.

Other examples of polymers in the polymer matrix can include polyvinylpyrrolidones, caprolactams, polyacrylamides, polyacrylamides, polyurethanes, maleic/(acrylate or methacrylate) copolymers, copolymers of methylvinyl ether and of maleic anhydride, copolymers of vinyl acetate and crotonic acid, copolymers of vinylpyrrolidone and of vinyl acetate, copolymers of vinylpyrrolidone and of caprolactam, vinyl pyrollidone/vinyl acetate copolymers, copolymers of anionic, cationic and amphoteric monomers, and combinations thereof. The polymers in the polymer matrix can may also be selected from naturally sourced polymers including those of plant origin examples of which include karaya gum, tragacanth gum, gum Arabic, acemannan, konjac mannan, acacia gum, gum ghatti, whey protein isolate, and soy protein isolate; seed extracts including guar gum, locust bean gum, quince seed, and psyllium seed; seaweed extracts such as Carrageenan, alginates, and agar; fruit extracts (pectins); those of microbial origin including xanthan gum, gellan gum, pullulan, hyaluronic acid, chondroitin sulfate, and dextran; and those of animal origin including casein, gelatin, keratin, keratin hydrolysates, sulfonic keratins, albumin, collagen, glutelin, glucagons, gluten, zein, and shellac.

The polymer matrix can be present in an amount of 25% or greater by weight, based on the weight of the soap composition. For example, the polymer matrix can be present in an amount of 30% or greater, 35% or greater, 40% or greater, 45% or greater, 50% or greater, 55% or greater, 60% or greater, 65% or greater, 70% or greater, 75% or greater, 80% or greater, 85% or greater, or 90% or greater by weight, based on the weight of the soap composition. In some embodiments, the polymer matrix can be present in an amount of 95% or less, 90% or less, 85% or less, 80% or less, 75% or less, 70% or less, 65% or less, 60% or less, 55% or less, 50% or less, 45% or less, 40% or less, 35% or less, 30% or less, 25% or less, or 20% or less by weight, based on the weight of the soap composition. In some embodiments, the polymer matrix can be present in an amount of from 20% to 95%, from 20% to 90%, from 25% to 90%, from 25% to 85%, from 25% to 80%, from 25% to 75%, from 25% to 65%, from 25% to 50%, from 30% to 85%, from 40% to 90%, from 40% to 85%, from 50% to 90%, from 50% to 85%, from 40% to 85%, from 50% to 80% or from 65% to 85% by weight, based on the weight of the soap composition.

Linker

As described herein, the soap compositions can include a linker. The linker can be any compound that can couple two or more components in the soap composition. For example, the linker can couple the polymer matrix to the polysaccharide and/or the fatty acid, linking them together. In some instances, the linker can form a bond between the polymer matrix and itself, i.e., a crosslinker. In some embodiments, the linker contains at least two functional groups, e.g., one functional group that can be used to form a bond with the polymer and another functional group that can be used to form a bond with another part of the polymer matrix (as in a crosslinker), the polysaccharide, and/or the fatty acid. After reacting with the polymer matrix, residual crosslinker may be used to link the polymer matrix to the polysaccharide and/or to the fatty acid.

In some aspects, the linker can comprise nucleophilic functional groups that can react with electrophilic functional groups on the polymer matrix, the polysaccharide, and/or the fatty acid, forming a bond. Alternatively, the linker can comprise electrophilic functional groups that can react with nucleophilic functional groups on the polymer matrix, the polysaccharide, and/or the fatty acid, forming a bond. Still further, the linker can comprise nucleophilic and electrophilic functional groups that can react with electrophilic and nucleophilic functional groups on the polymer matrix, the polysaccharide, and/or the fatty acid, forming a bond.

While the disclosed polymer matrix, polysaccharide, and/or fatty acid can be attached to each other directly, the use of a linker, as is described herein, can allow more distance (and thus more freedom to move) between the polymer matrix, polysaccharide, and/or the fatty acid. The linker can be of varying lengths, such as from 1 to 20 atoms in length. For example, the linker can be from 1, 2, 3, 4, 5, 6, 7, 8, 9, 10, 11, 12, 13, 14, 15, 16, 17, 18, 19, or 20 atoms in length, where any of the stated values can form an upper and/or lower end point where appropriate. As noted, the longer the linker, the greater freedom of movement the components in the soap composition can have. Further, the linker can be substituted or unsubstituted. When substituted, the linker can contain substituents attached to the backbone of the linker or substituents embedded in the backbone of the linker. For example, an amine substituted linker can contain an amine group attached to the backbone of the linker or a nitrogen in the backbone of the linker. Suitable moieties for the linker include, but are not limited to, substituted or unsubstituted, branched or unbranched, alkyl, alkenyl, or alkynyl groups, ethers, esters, polyethers, polyalkylenes, polyamines, heteroatom substituted alkyl, alkenyl, or alkynyl groups, cycloalkyl groups, cycloalkenyl groups, heterocycloalkyl groups, heterocycloalkenyl groups, and the like, and derivatives thereof.

In one aspect, the linker can comprise a C₁-C₆ branched or straight-chain alkyl, such as methyl, ethyl, n-propyl, iso-propyl, n-butyl, iso-butyl, sec-butyl, tent-butyl, n-pentyl, iso-pentyl, neopentyl, or hexyl. In a specific example, the linker can comprise —(CH₂)ₙ, wherein n is from 1 to 5. In another aspect, the linker can comprise a C₁-C₆ branched or straight-chain alkoxy such as a methoxy, ethoxy, n-propoxy, iso-propoxy, n-butoxy, iso-butoxy, sec-butoxy, tert-butoxy, n-pent oxy, iso-pentoxy, neopentoxy, or hexoxy.

In still another aspect, the linker can comprise a C₂-C₆ branched or straight-chain alkyl, wherein one or more of the carbon atoms is substituted with oxygen (e.g., an ether) or an amino group. For example, suitable linkers can include, but are not limited to, a methoxymethyl, methoxyethyl, methoxypropyl, methoxybutyl, ethoxymethyl, ethoxyethyl, ethoxypropyl, propoxymethyl, propoxyethyl, methylaminomethyl, methylaminoethyl, methylaminopropyl, methylaminobutyl, ethylaminomethyl, ethylaminoethyl, ethylaminopropyl, propylaminomethyl, propylaminoethyl, methoxymethoxymethyl, ethoxymethoxymethyl, methoxyethoxymethyl, methoxymethoxyethyl, and the like, and derivatives thereof. In one specific example, the linker can comprise a methoxymethyl (i.e., —CH₂—O—CH₂—).

Other suitable examples of linkers include compounds comprising proteins, peptides, or receptors that possess amino acid residues with a nucleophilic or potentially nucleophilic amine, carboxylate or carboxylic acid, alcohol, or thiol functional group (e.g., cysteine, serine, threonine, tryptophan, tyrosine, aspartic acid, glutamic acid, glutamine, arginine, histidine, and lysine), aldehydes, acyl derivatives (e.g., acyl azides, acyl nitriles), esters and activated esters (e.g., succinimidyl esters, sulfosuccinimidyl esters), anhydrides, epoxides, and mixed anhydrides, derivatized carboxylic acids and carboxylates, imines, isocyanates, isothiocyanates, sulfonyl chlorides, organo-halides, maleimides, and combinations thereof. Some specific examples of suitable electrophilic linkers include paraformaldehyde, dialdehydes, and diesters. Examples of suitable dialdehydes include, but are not limited to, gluteraldehyde, glyoxal, methylglyoxal, glyoxic acid, dimethyl-glyoxal, malonic dialdehyde, succinic dialdehyde, adipic dialdehyde, 2-hydroxyadipic dialdehyde, pimelic dialdehyde, suberic dialdehyde, azelaic dialdehyde, sebacic dialdehyde, maleic aldehyde, fumaric aldehyde, 1,3-benzenedialdehyde, phthalaldehyde, isophthalaldehyde, terephthalaldehyde, 1,4-diformylcyclohexane, and the like. Equivalents of dialaldehydes that can be used instead of a dialdehyde include, 2,5-dialkoxytetrahydrofurans, 1,4-dialdehyde monoacetals, 1,4-dialdehyde diacetals. Examples of diesters include, but are not limited to, dialkyl oxylate, dialkyl fumarate, dialkyl malonate, dialkyl succinate, dialkyl adipate, dialkyl azelates, dialkyl suberate, dialkyl sebacate, dialkyl terephthalate, dialkylisophthalate, dialkylphthalate, and the like. Examples of diones include heptane-2,6-dione, hexane-2,5-dione, pentane-2,4-dione, and the like. Examples of diisocyanates include, but are not limited to, 1,3-phenyldiisocyanate, 1,4-phenyldiisocyanate, 1,4-cyclohexyldiisocyanate, toluene diisocyanate, and 1,6-hexane-diisocyanate.

A still further example of a suitable linker is epichlorohydrin.

Also, when a linker is not generally reactive it can be converted into a more reactive linker. For example, linkers that contain carboxylate or carboxylic acid groups can, depending on the conditions, be slow to react with a nucleophilic substituent on an active substance. However, these linkers can be converted into more reactive, activated esters by a carbodiimide coupling with a suitable alcohol, e.g., 4-sulfo-2,3,5,6-tetrafluorophenol, N-hydroxysuccinimide or N-hydroxysulfosuccinimide. This results in a more reactive, water-soluble activated ester linking moiety. Various other activating reagents that can be used for the coupling reaction include, but are not limited to, 1-ethyl-3-(3-dimethylaminopropyl) carbodiimide (EDC), dicyclohexylcarbodiimide (DCC), N,N′-diisopropyl-carbodiimide (DIP), benzotriazol-1-yl-oxy-tris-(dimethylamino)phosphonium hexa-fluorophosphate (BOP), hydroxybenzotriazole (HOBt), and N-methylmorpholine (NMM), including mixtures thereof).

When an active substance (e.g., a polymer matrix) contains an amine functional group, it can be particularly reactive toward linkers with electrophilic functional groups. Such amine containing active substances can react with the linker and form, for example, depending on the linker's functional groups, amine, amide, imines, imides, carboxamide, sulfonamide, urea, or thiourea bonds. When the active substance (e.g., a fatty acid) contains a carboxylate, they can react with the linker and form, for example, depending on the linker's functional groups, esters, thioesters, carbonates, or mixed anhydrides. When the active substance contains an alcohol or thiol, they can react with the linker's functional group and form, for example, esters, thioesters, ethers, sulfides, disulfides, carbonates, or urethanes. Isocyanate linkers are readily derivable from acyl azide linkers, and they react with active substances that contain amine functional groups to form ureas, they react with active substances that contain alcohols to form urethanes, and they react with active substances that contain thiols to form thiourethanes. Isothiocyanate linkers can react with an amine, alcohol, or thiol containing cell-surface substituents to form thioureas and thiourethanes. Succinimidyl ester linkers can also react with active substances that contain amine, carboxylate, alcohol, or thiol functional groups. Sulfonyl chloride containing linkers can react with phenols (including tyrosine), aliphatic alcohols (including polysaccharides), thiols (such as cysteine) and imidazoles (such as histidine).

Aldehyde containing linkers can react with nucleophilic substituents that contain amines to form Schiff bases. Organo-halide containing linkers contain a carbon atom bonded to a halide (e.g., fluorine, chlorine, bromine, or iodine). These moieties can react with active substances that contain amine, carboxylate, alcohol, or thiol functional group to form, for example, amine, ester, ether, or sulfide bonds.

The linker can also include hydrazines, amines, alcohols, carboxylates, or thiols. When the linker contains an amine functional group, it can be particularly reactive toward an active substance comprising an electrophilic functional group. Such amine containing linkers can react with the active substance and form, for example, depending on the electrophilic functional group on the active substance, amide, imides, imines, carboxamide, sulfonamide, urea, or thiourea bonds. When the linker contains a carboxylate, they can react with the active substance's electrophilic functional group and form, for example, esters, thioesters, carbonates, or mixed anhydrides. When the linker contains an alcohol or thiol, they can react with the active substance's electrophilic functional group and form, for example, depending on the substituent, esters, thioesters, ethers, sulfides, disulfides, carbonates, or urethanes.

In yet another example, a carbodiimide-mediated coupling can be used to form a bond between the linker and the active substance. For example, a linker with a hydrazine or amine group can be coupled to an active substance with carboxylate or carboxylic acid functional groups using water-soluble carbodiimides such as 1-ethyl-3-(3-dimethylaminopropyl)carbodiimide. Suitable linkers capable of carbodiimide-mediate coupling to carboxylate or carboxylic acid containing active substances are commercially available. Specific examples of such linkers include, but are not limited to, water soluble carbodiimides such as 1-ethyl-3-(3-dimethylaminopropyl)-carbodiimide HCl and 1-cyclohexyl-3-(2-morpholinoethyl)-carbodiimide-metho-p-toluene sulfonate, alcohol and water soluble N-ethyoxycarbonyl-2-ethoxy-1,2-dihydroquinoline, and organic soluble N,N′-dicyclohexylcarbodiimide.

Polysaccharide

As described herein, the polymer matrix can comprise a polysaccharide that is substantially homogeneously distributed within the matrix. As used herein, “substantial” or “substantially” refers to a condition that when so modified is understood to not necessarily be absolute or perfect but would be considered close enough to those of ordinary skill in the art to warrant designating the condition as being present. As a non-limiting example, if a polysaccharide is characterized as being “substantially homogenously” dispersed in a medium, 80% or more, 90% or more homogeneous, or 95% or more homogeneous dispersion would be understood by one of ordinary skill in the art to fulfill the requirement. As used herein, “homogeneous” or “homogeneously” refers to a solution or layer in which a solute or dispersant is uniformly dispersed throughout a dispersing medium such that a sample taken from anywhere in the solution or the layer will have the same composition as a sample taken from anywhere else in the solution or layer. Suitable methods for distributing or dispersing the polysaccharide substantially homogeneously within the matrix of the polymer matrix are described herein. It is also contemplated that more than one kind of polysaccharide, as are described herein, can be used in the disclosed compositions and methods.

Generally, the polysaccharide in the soap composition can be any polysaccharide that can exhibit antimicrobial and/or exfoliating properties. In some examples, the polysaccharide exhibits both antimicrobial and exfoliating properties. Suitable examples of polysaccharides for use in the soap compositions can include chitin (poly β-(1→4)-2-acetamido-2-deoxy-D-glucopyranose) or a derivative thereof. A suitable derivative of chitin that can be used in the soap composition is chitosan, poly β-(1→4)-2-amino-2-deoxy-D-glucopyranose that may be obtained by alkaline deacetylation of chitin. In some examples, the polysaccharide in the soap composition can include cellulose. In other examples, the polysaccharide in the soap composition can include chitosan.

The polysaccharide can be in the form of particles to aid in exfoliating properties of the soap composition. The particles can be solids substantially homogenously distributed in the polymer matrix, which may act as an abrasive when the soap composition is used to cleanse skin. The abrasive may remove dead skin cells from the surface of the skin. Removal of the dead skin cells from the surface of the skin may allow improved access and deeper penetration of other components in the soap compositions, such as surfactants and moisturizers. This may improve both the feel and appearance of skin.

The polysaccharide can be present in an amount of 1% or greater by weight, based on the weight of the soap composition. For example, the polysaccharide can be present in an amount of 2% or greater, 4% or greater, 5% or greater, 8% or greater, 10% or greater, 12% or greater, 15% or greater, 18% or greater, 20% or greater, 22% or greater, 25% or greater, 30% or greater, 32% or greater, or 35% or greater by weight, based on the weight of the soap composition. In some embodiments, the polysaccharide can be present in an amount of 35% or less, 30% or less, 25% or less, 20% or less, 18% or less, 15% or less, 12% or less, 10% or less, 8% or less, or 5% or less by weight, based on the weight of the soap composition. In some embodiments, the polysaccharide can be present in an amount of from 1% to 35%, from 5% to 35%, from 5% to 30%, from 5% to 25%, from 5% to 20%, from 10% to 30%, from 10% to 25%, or from 10% to 20% by weight, based on the weight of the soap composition.

The weight ratio of polymer matrix to the polysaccharide in the soap compositions can be varied. It can depend on such factors as the type of polymer in the polymer matrix and the desired amount of polysaccharide to be entrapped. For example, a range of from 100:1 to 1:2 by weight of polymer matrix to polysaccharide is contemplated. More usual weight ratios contemplated are from 100:1 to 1:1, from 75:1 to 5:1, from 50:1 to 10:1, from 75:1 to 25:1, from 100:1 to 50:1, from 50:1 to 1:2, or from 10:1 to 1:2.

Fatty Acid

As described herein, the soap composition can also include a fatty acid. The fatty acid can have a melting point greater than 20° C. The fatty acid may be saturated or unsaturated and/or branched or unbranched. In some examples, the soap compositions can include one or more C₈-C₂₂ fatty acids, such as C₁₀-C₂₂, C₁₀-C₂₀, C₁₀-C₁₈, or C₁₀-C₁₆ fatty acids. Specific examples of fatty acids that can be used in the soap compositions described herein can include lauric acid, linoleic acid, myristic acid, palmitic acid, palmitoleic acid, oleic acid, stearic acid, hydroxy stearic acid, behenic acid, or a mixture thereof.

The fatty acid can be reacted with the polymer matrix and/or the polysaccharide. In some examples, the fatty acid can be reacted with a linker prior to reacting with the polymer matrix and/or the polysaccharide.

The fatty acid can be present in an amount of 1% or greater by weight, based on the weight of the soap composition. For example, the fatty acid can be present in an amount of 2% or greater, 3% or greater, 4% or greater, 5% or greater, 6% or greater, 7% or greater, 8% or greater, or 9% or greater by weight, based on the weight of the soap composition. In some embodiments, the fatty acid can be present in an amount of 10% or less, 9% or less, 8% or less, 7% or less, 6% or less, 5% or less, 4% or less, 3% or less, 2% or less, or 1.5% or less by weight, based on the weight of the soap composition. In some embodiments, the polymer matrix can be present in an amount of from 1% to 10%, from 1% to 8%, from 1% to 5%, from 2% to 10%, from 2% to 8%, or from 2% to 5% by weight, based on the weight of the soap composition.

Surfactant

The soap compositions described herein can also include one or more surfactants. The one or more surfactants can be anionic, cationic, nonionic, amphoteric, or a mixture thereof. Suitable anionic surfactants can include a negatively charged hydrophilic end group such as a sulfate, sulfonate, carboxylate, or phosphate. Suitable cationic surfactants can include surfactants having a positively charged hydrophilic end such as a quaternary amine. Suitable non-ionic surfactants can include surfactants having a neutral hydrophilic end, such as an ethoxylate, glycoside, or polyol. Amphoteric or zwitterionic surfactants may have both a positive and negative charge on their hydrophilic ends, such as amine oxides, sultaines, or betaines.

Examples of cationic surfactants include long chain amines; quaternary ammonium salts such as di(C₈-C₂₄)alkyldimethylammonium chloride or bromide; di(C₁₂-C₁₈) alkyldimethylammonium chloride or bromide; distearyldimethylammonium chloride or bromide; ditallowalkyldimethylammonium chloride or bromide; dioleyldimethylammonium chloride or bromide; dicocoalkyldimethylammonium chloride or bromide; (C₈-C₂₄) alkyldimethylethylammonium chloride or bromide; (C₈-C₂₄) alkyltrimethylammonium chloride or bromide; cetyltrimethylammonium chloride or bromide; (C₂₀-C₂₂) alkyltrimethylammonium chloride or bromide; (C₈-C₂₄) alkyldimethylbenzyl-ammonium chloride or bromide; N—(C₁₀-C₁₈) alkylpyridinium chloride or bromide; N—(C₁₀-C₁₈) alkylisoquinolinium chloride, bromide or monoalkylsulfate; N—(C₁₂-C₁₈) alkylpolyoylaminoformylmethylpyridinium chloride; N—(C₁₂-C₁₈) alkyl-N-methylmorpholinium chloride, bromide or monoalkylsulfate; N—(C₁₂-C₁₈) alkyl-N-ethylmorpholinium chloride, bromide or monoalkylsulfate; (C₁₆-C₁₈) alkylpentaoxethylammonium chloride; diisobutylphenoxyethoxyethyl dimethylbenzylammonium chloride; salts of N,N-diethylaminoethylstearylamide and -oleylamide with hydrochloric acid, acetic acid, lactic acid, citric acid, and phosphoric acid; N-acylaminoethyl-N,N-diethyl-N-methylammonium chloride, bromide or monoalkylsulfate; and N-acylaminoethyl-N,N-diethyl-N-benzylammonium chloride, bromide or monoalkylsulfate, where acyl is stearyl or oleyl; and combinations thereof.

Examples of anionic surfactants include, but are not limited to, sulfates, such as sodium laureth sulfate; ammonium laureth sulfate; alkylpolysaccharide sulfates, such alkylpolyglycoside sulfates; branched primary alkyl sulfates; alkyl glyceryl sulfates; alkenyl glyceryl sulfates; alkylphenol ether sulfates; or oleyl glyceryl sulfates; alkyl succinates; sulfonates, such as alkylbenzene sulfonates; or alkyl ester sulfonates, including linear esters of C₈-C₂₀-carboxylic acids (i.e., fatty acids) which are sulfonated by means of gaseous SO₃ carboxylates; phosphates, such as alkyl phosphates; alkyl ether phosphates; isethionates, such as acyl isethionates; sulfosuccinates, including monoesters of sulfosuccinates (such as saturated and unsaturated C₁₂-C₁₈ monoesters); or diesters of sulfosuccinates (such as saturated and unsaturated C₁₂-C₁₈ diesters); acyl sarcosinates, such as those formed by reacting fatty acid chlorides with sodium sarcosinate in an alkaline medium; salts of acylaminocarboxylic acids, such as salts of alkylsulfamidocarboxylic acids; N-acyltaurides; and combinations thereof. Suitable starting materials for anionic surfactants are natural fats, such as tallow, coconut oil and palm oil, but can also be of a synthetic nature.

Examples of nonionic surfactants include, but are not limited to, glucosides, such as lauryl glucoside and decyl glucoside, and the ethoxylated alcohols and ethoxylates of long-chain, aliphatic, synthetic or native alcohols having a C₈-C₂₂ alkyl radical. These ethoxylated alcohols and can contain from about 1 to about 25 moles of ethylene oxide. The alkyl chain of the aliphatic alcohols can be linear or branched, primary or secondary, saturated or unsaturated. Condensation products of C₁₀-C₁₈ alcohols with from about 2 to about 18 moles of ethylene oxide per mole of alcohol can be used. The alcohol ethoxylates can have a narrow homolog distribution (“narrow range ethoxylates”) or a broad homolog distribution of the ethylene oxide (“broad range ethoxylates”). Amides-fatty acid combinations, such as coconut amides, including cocamide diethanolamine, cocamide monoethanolamine, are also useful.

Examples of amphoteric surfactants include, but are not limited to, betaines, sultaines, imidazoline derivatives, and the like. Typical amphoteric surfactants include disodium cocoamphodiacetate, ricinoleamidopropyl betaine, cocamidopropyl betaine, stearyl betaine, stearyl amphocarboxy glycinate, sodium lauraminopropionate, cocoamidopropyl hydroxy sultaine, disodium lauryliminodipropionate, tallowiminodipropionate, cocoampho-carboxy glycinate, cocoimidazoline carboxylate, lauric imidazoline monocarboxylate, lauric imidazoline dicarboxylate, lauric myristic betaine, coamidosulfobetaine, alkylamidophospho betaine, and combinations thereof.

In addition to the foregoing surfactants, suitable blends of surfactants include, but not limited to, blends of linear alkylbenzene sulfonate, coconut amide, and mixed ethoxylated alcohols (sold as COLADET SDC by Colonial Chemical, Inc., South Pittsburgh, Tenn.); blends of anionic-amide surfactants (sold as COLADET DC-6 by Colonial Chemical, Inc.); blends of ammonium laureth sulfate, disodium cocoamphodiacetate, lauryl glucoside, decyl glucoside, and cocamidopropyl betaine (sold as COLADET GBP by Colonial Chemical, Inc.); blends of potassium cocoate (sold as COLADET KC-40 by Colonial Chemical, Inc.); proprietary blends of nonionic surfactants, for example COLADET RA-300 by Colonial Chemical, Inc.; or any combination thereof. Other examples of suitable surfactants include sodium dodecylbenzenesulfonate, deoxycholic acid, lauramidopropyl betaine, lauryl betaine, lauryl sultaine, lauryl sulfate, lauryl sulfonate, cocamidopropyl betaine, myristyl betaine, myristyl sultaine, myristyl sulfate, myristyl sulfonate, cetyl betaine, cetyl sultaine, cetyl sulfate, cetyl sulfonate, stearyl betaine, stearyl sultaine, stearyl sulfate, stearyl sulfonate, alkylphenol ethoxylates, polyetholylated alkyl alcohols, or combinations thereof.

The surfactant can be present in an amount of 1% or greater by weight, based on the weight of the soap composition. For example, the surfactant can be present in an amount of 2% or greater, 3% or greater, 4% or greater, 5% or greater, 10% or greater, 15% or greater, 20% or greater, 25% or greater, 30% or greater, 35% or greater, 40% or greater, 45% or greater, 50% or greater, 55% or greater, or 60% or greater by weight, based on the weight of the soap composition. In some embodiments, the fatty acid can be present in an amount of 60% or less, 55% or less, 50% or less, 45% or less, 40% or less, 35% or less, 30% or less, 25% or less, 20% or less, 15% or less, 10% or less, or 5% or less by weight, based on the weight of the soap composition. In some embodiments, the fatty acid can be present in an amount of from 0.1% to 60%, from 1% to 60%, from 5% to 60%, from 10% to 60%, from 20% to 60%, from 30% to 60%, from 10% to 50%, from 20% to 50%, from 30% to 50%, from 25% to 55% by weight, or from 20% to 40% by weight, based on the weight of the soap composition.

The soap compositions can further comprise a fragrance. The fragrance can be in an amount from 0.1% to 2% by weight, based on the total weight of the soap composition. Suitable fragrances include volatile aromatic esters, non-aromatic esters, aromatic aldehydes, non-aromatic aldehydes, aromatic alcohols, non-aromatic alcohols, heterocyclic aroma chemicals, natural floral fragrances such as blossom, carnation, gardenia, geranium, iris, hawthorne, hyacinth and jasmine, and combinations thereof.

The soap compositions may further comprise other optional ingredients that are known for use or otherwise useful in personal care compositions, provided that such optional materials are compatible with the materials described herein, or do not otherwise unduly impair the soap's performance. Such optional ingredients can include those materials approved for use in cosmetics and that are described in reference books such as the CTFA Cosmetic Ingredient Handbook, Second Edition, The Cosmetic, Toiletries, and Fragrance Association, Inc. 1988, 1992. Examples of such optional ingredients include preservatives, coloring agents or dyes, conditioning agents, fragrance, surfactants, thickeners, moisturizers, emollients, pharmaceutical actives, vitamins or nutrients, sunscreens, deodorants, sensates, plant extracts, nutrients, astringents, cosmetic particles, absorbent particles, adhesive particles, fibers, reactive agents, skin tanning agents, exfoliating agents, acids, bases, humectants, enzymes, suspending agents, pH modifiers, pigment particles, anti-microbial agents, co-solvents or other additional solvents, anti-inflammatory agents, anesthetics, enzymes, UV-absorbers, antiperspirants, deodorants, hydroxy aids, skin lightening agents, medications, antibiotics, antifungal agents, insect repellents, and similar other materials.

The optional ingredients can be present in an amount of from 0% to 10%, from 3% to 8%, or from 4% to 7% by weight, based on the weight of the soap composition.

In some examples, the soap compositions can include a polyhydric alcohol. The polyhydric alcohol can be an alkylene glycol or polyalkylene glycol such as glycerol, sorbitol, mannitol, alkylene glycol, and polyalkylene glycol. Other optional ingredients can include latex or emulsion polymers, thickeners such as water soluble polymers, clays, silicas, ethylene glycol distearate, deposition aids, including coacervate forming components and quaternary amine compounds.

The soap compositions can also include water. Water can be present in an amount of from 0.1% to 25%, from 0.1% to 10%, or from 1% to 10% by weight, based on the weight of the soap composition. In some embodiments, the soap compositions are free or substantially free of water.

Products

The soap compositions can be produced in any of a variety of product forms, including a dry, solid material. Regardless of the product form, the soap compositions contemplated within the scope of the present disclosure can be defined by a composition comprising a polymer matrix, a polysaccharide substantially dispersed in the polymer matrix, and a fatty acid.

The soap compositions can be in the form of a sheet or pad for use alone or in combination with other personal care components (e.g., water). The sheet or pad can be of an adequate size to be able to be handled easily by the user. In some examples, the sheet may have a square, rectangle or disc shape or any other suitable shape. The pads can be in the form of a continuous strip including delivered on a tape-like roll dispenser with individual portions dispensed via perforations and or a cutting mechanism. Alternatively, the compositions can be in the form of one or more cylindrical objects, spherical objects, tubular objects or any other shaped object.

The compositions may comprise one or more textured, dimpled or otherwise topographically patterned surfaces including letters, logos or figures. The textured composition may result from the shape of a substrate, in that the outermost surface of the substrate contains portions that are raised with respect to other areas of the surface. The raised portions can be the result of creping processes, imprinted coatings, embossing patterns, laminating to other layers having raised portions, or the result of the physical form of the dissolvable porous solid substrate itself. The texturing can also be the result of laminating the substrate to a second substrate that is textured.

In some embodiments, the sheets can be perforated with holes or channels penetrating into or through the soap composition. These perforations can be formed via spikes extended from the surface of the underlying mold, belt or other non-stick surface. Alternatively, these perforations can be formed after the drying process via poking or sticking the porous solids with pins, needles or other sharp objects. In some examples, these perforations are great in number per surface area, but not so great in number so as to sacrifice the integrity or physical appearance of the soap composition. The perforations can increase the dissolution rate of the soap compositions into water relative to un-perforated soap compositions.

Kits

The soap composition can be in packages containing a stack of the soap sheets or can be in packages containing only a single sheet. The soap sheet thickness can be tailored as desired. In one aspect, the sheet soap thickness can be from 25 microns to 5 mm. for example, the thickness can be from 500 microns to 2.5 mm or from 750 microns to 2.0 mm.

The packaging can comprise plastic bags, paper containers, plastic containers, elastic bands, or any other desired packaging materials.

### Methods

Methods of making the soap compositions are also disclosed herein. As described herein, the soap compositions can include a polymer matrix comprising a polysaccharide that is substantially homogenously dispersed in a polymer matrix, and a fatty acid. The polymer matrix can be covalently linked to the fatty acid and/or the polysaccharide. In some examples, the polymer matrix can be directly linked to the fatty acid and/or the polysaccharide. In some examples, the polymer matrix can be functionalized with a linker and then linked with the fatty acid and/or the polysaccharide. In some examples, the linker can crosslink the polymer matrix.

Methods for linking for example, the polymer matrix and the polysaccharide and/or fatty acid to a linker or to each other are disclosed herein. Other methods for coupling the polymer matrix and the polysaccharide and/or fatty acid to a linker or to each other are reactions known in the art. The particular method will depend on the specific polymer, polysaccharide, fatty acid, and linker (if used).

In some aspects, the method of making the soap compositions can be carried out in a neat solution or dispersion. Said another way, the method can be carried free or substantially free of a solvent. The phrase “substantially free” is used synonymously with “substantially absent” and refers to less than five (5) weight percent of, for example, of a solvent present the soap solution or dispersion. In some examples, the soap compositions include less than one (1) percent by weight of a solvent.

In some examples, the method for preparing the soap compositions can include blending the polymer matrix, the polysaccharide, and the fatty acid to form a substantially homogenous mixture. In a further aspect, the method can include contacting the polymer matrix with a linker, wherein the linker bonds to the polymer matrix, thereby providing a polymer matrix-linker substrate. The polymer matrix-linker substrate can be reacted with the polysaccharide and/or the fatty acid. In another aspect, the linker can be contacted to the polysaccharide and/fatty acid prior to contacting the polymer matrix with the linker. Still further, the linker can be contacted to the polymer matrix, the polysaccharide, and/or the fatty acid at the same time.

The method for preparing the soap compositions can include mixing the substantially homogenous mixture at or above the melting temperature of the lowest melting polymer in the soap composition. In some embodiments, the method can include mixing the substantially homogenous mixture above the melting temperature of the polymer in the polymer matrix. For example, the substantially homogenous mixture can be mixed at a temperature of 50° C. or greater, 60° C. or greater, 70° C. or greater, 80° C. or greater, 90° C. or greater, 100° C. or greater, 110° C. or greater, 120° C. or greater, 130° C. or greater, or 150° C. or greater. In some embodiments, the substantially homogenous mixture can be mixed at a temperature of 150° C. or less, 140° C. or less, 130° C. or less, 120° C. or less, 110° C. or less, 100° C. or less, 90° C. or less, 80° C. or less, 70° C. or less, 60° C. or less, or 50° C. or less. In some embodiments, the substantially homogenous mixture can be mixed at a temperature from 50° C. to 150° C., from 60° C. to 150° C., from 60° C. to 130° C., from 70° C. to 150° C., or from 70° C. to 130° C.

In some embodiments, the method can include dispersing the substantially homogenous mixture onto a surface and dried into sheet form. Sheet soaps can be formed from such mixtures or solutions by shaping them into a solidified form of suitable thickness by techniques known in the art (e.g., wet casting, freeze-drying, and extrusion molding). The soap sheet can be dried/solidified at standard temperature and/or pressure, or at lower or elevated temperature and/or pressure compared to standard conditions.

A coating of any desired additive or component can be applied to the soap sheet following formation. The coating can include, for example, humectants or moisturizers. In one aspect, the coating includes one or more emollients. The emollient coating provides a skin moisturizing benefit. In addition, the emollient coating provides a moisture barrier to protect the integrity of the sheet soap from the environment.

The disclosed methods and compositions are also applicable to the preparation of other forms of soap products, e.g., films, flakes, pads, fibers, or gels.

The soap compositions described herein is convenient for general travel or transportation because it is lightweight, lacking additional weight from water or liquids. In addition, the soap compositions are convenient for airplane travel, which restricts liquid volumes in carry-on baggage. Further, the packaged soap compositions are substantially waterless, reducing the risk of leakage compared to conventional liquid or foam soaps.

As disclosed herein, the soap compositions can soften at low temperatures, such as from 35° C. to 70° C., in the absence of a solvent. In some embodiments, the soap sheets can soften with from 1 to 30 strokes, from 2 to 25 strokes, from 3 to 20 strokes, or from 4 to 15 strokes. In some embodiments, the soap compositions can be dissolvable or dispersible. The term “dissolvable” refers to the soap (such as a sheet) meets the hand dissolution value. The soap sheets can have a hand dissolution value of from 1 to 30 strokes, from 2 to 25 strokes, from 3 to 20 strokes, or from 4 to 15 strokes as measured by the Hand Dissolution Method.

### EXAMPLES

The following examples are for purposes of illustration only and are not intended to limit the scope of the claims.

### Example 1: Biodegradable Chitin Soap Sheets

This example provides a unique soap blend with improved antibacterial/antimicrobial properties by using the biorenewable/biodegradable material chitin.

Materials: PEG (˜77%); chitin (˜17.5%); lauric acid (˜4.1%); vanillin (˜1.4%).

Method: A combination of the matrix (PEG), fatty acid, odorant, and chitin was blended to create a homogenous soap blend. All materials were combined in a glass reaction vessel. The reactor was sealed and placed under N₂ with a stir apparatus connected. The mixture was brought to ˜70° C. (slightly above the melting point of PEG) to provide a liquid matrix for mixing. The temperature was monitored and kept near 70° C. while the materials mixed for ˜2 hours, which appeared to be enough time to obtain a homogenous mixture. The homogenous mixture was removed from heat poured onto a glass sheet while still hot.

Soap samples between 1.4 and 1.7 g were weighed. Each individual sample was placed between two sheets of Kapton film then heated to ˜70° C. to get a melt. The viscous samples were then rolled between the two pieces of Kapton film to create thin sheets. The soap sheets were cut into identical discs to simulate a finished product.

Embodiments of the Soap Composition

1. The soap composition can comprise a polymer matrix comprising a first polymer, a polysaccharide that is substantially homogenously distributed within the polymer matrix, and a fatty acid.

2. The soap composition of any one of the preceding embodiment, wherein the first polymer can be selected from a polyalkylene oxide, a polyamine, a polyimine, a polyalcohol, a polyvinyl acetate, a polycarboxylic acid, a polyanhydride, cellulose, a blend thereof, or a copolymer thereof.

3. The soap composition of any one of the preceding embodiments, wherein the first polymer can include a polyalkylene oxide, a polyalcohol, cellulose, a blend thereof, or a copolymer thereof.

4. The soap composition of any one of the preceding embodiments, wherein the first polymer can include a polyalkylene oxide.

5. The soap composition of any one of the preceding embodiments, wherein the first polymer can include a polyalcohol.

6. The soap composition of any one of the preceding embodiments, wherein the first polymer can be selected from polyvinyl amine, polyetheramine, polyoxyalkylene amine, polyalkyleneimine, polyethylene oxide, polypropylene oxide, polyvinyl alcohol, polyethylene-vinyl acetate copolymer, polyethylene-vinyl alcohol copolymer, polylactic acid, polylactic acid-glycolic acid copolymer, polylactic acid-succinic acid copolymer, a blend thereof, or a copolymer thereof.

7. The soap composition of any one of the preceding embodiments, wherein the first polymer can be selected from polyethylene oxide, polypropylene oxide, a blend thereof, or a copolymer thereof.

8. The soap composition of any one of the preceding embodiments, wherein the first polymer can include polyvinyl alcohol.

9. The soap composition of any one of the preceding embodiments, wherein the first polymer in the polymer matrix can be crosslinked with a linker.

10. The soap composition of any one of the preceding embodiments, wherein the linker, prior to crosslinking the first polymer, can comprise an aldehyde, an epoxide, a ketone, an ether, an ester, an isocyanate, an amine, an amino acid, a hydroxyl, a substituted or unsubstituted alkyl, alkenyl, or alkynyl group, an alkoxy, or a combination thereof.

11. The soap composition of any one of the preceding embodiments, wherein the linker, prior to crosslinking the first polymer, can comprise a dialdehyde, formaldehyde, a paraformaldehyde, glycidol, epichlorohydrin, a dione, a diisocyanate, an ether amine, an amino aldehyde, an amino ester, a hydroxy aldehyde, a hydroxy ester, or a combination thereof.

12. The soap composition of any one of the preceding embodiments, wherein the polymer matrix can be present in an amount of from 25% to 90% by weight, based on the total weight of the soap composition.

13. The soap composition of any one of the preceding embodiments, wherein the polymer matrix can be present in an amount of from 50% to 90% by weight, based on the total weight of the soap composition.

14. The soap composition of any one of the preceding embodiments, wherein the polymer matrix can be present in an amount of from 65% to 85% by weight, based on the total weight of the soap composition.

15. The soap composition of any one of the preceding embodiments, wherein the polysaccharide can comprise chitin, cellulose, or a combination thereof.

16. The soap composition of any one of the preceding embodiments, wherein the polysaccharide can comprise chitin.

17. The soap composition of any one of the preceding embodiments, wherein the polysaccharide can be present in an amount of from 1% to 35% by weight, based on the total weight of the soap composition.

18. The soap composition of any one of the preceding embodiments, wherein the polysaccharide can be present in an amount of from 10% to 25% by weight, based on the total weight of the soap composition.

19. The soap composition of any one of the preceding embodiments, wherein the fatty acid can comprise a C₈-C₂₂ fatty acid.

20. The soap composition of any one of the preceding embodiments, wherein the fatty acid can comprise lauric acid, palmitic acid, palmitoleic acid, stearic acid, oleic acid, linoleic acid, myristic acid, or a mixture thereof.

21. The soap composition of any one of the preceding embodiments, wherein the fatty acid can be present in an amount of from 1% to 10% by weight, based on the total weight of the soap composition.

22. The soap composition of any one of the preceding embodiments, wherein the fatty acid can be covalently linked to the first polymer.

23. The soap composition of any one of the preceding embodiments, wherein the fatty acid can be covalently linked to the linker in the polymer matrix.

24. The soap composition of any one of the preceding embodiments, further comprising a surfactant.

25. The soap composition of any one of the preceding embodiments, further comprising a fragrance.

26. A method of preparing a soap composition of any one of the preceding embodiments comprising blending the polymer matrix, the polysaccharide, and the fatty acid to form a substantially homogenous mixture, wherein the mixture does not include a solvent.

27. The method of any one of the preceding embodiments, wherein the polymer matrix can comprise a first polymer selected from polyalkylene, polyalkylene oxide, polyamine, polyimine, polyalcohol, a polyvinyl acetate, a polycarboxylic acid, a polyanhydride, cellulose, a blend thereof, or a copolymer thereof.

28. The method of any one of the preceding embodiments, wherein the first polymer in the polymer matrix further can comprise a linker.

29. The method of any one of the preceding embodiments, further comprising reacting the linker with the polymer matrix prior to blending with the polysaccharide and the fatty acid.

30. The method of any one of the preceding embodiments, wherein the method can comprise heating the substantially homogenous mixture at or above the melting temperature of the lowest melting polymer in the substantially homogenous mixture.

31. The method of any one of the preceding embodiments, wherein the method can comprise heating the substantially homogenous mixture at or above the melting temperature of the polymer matrix.

32. The method of any one of the preceding embodiments, wherein the method can comprise heating the substantially homogenous mixture at a temperature of 150° C. or less.

33. The method of any one of the preceding embodiments, wherein the polymer matrix and the fatty acid can react to form a covalent bond.

34. A soap composition comprising a surfactant in an amount from 30% to 60% by weight, based on the total weight of the soap composition, a polysaccharide in an amount from 1% to 35% by weight, based on the total weight of the soap composition, a fatty acid in an amount from 1% to 10% by weight, based on the total weight of the soap composition, and a polymer matrix in an amount from 25% to 50% by weight, based on the total weight of the soap composition.

35. The soap composition of the preceding embodiment, wherein the surfactant can include an anionic, cationic, amphoteric, or nonionic surfactant.

36. The soap composition of the preceding embodiment, wherein the surfactant can include sodium dodecylbenzenesulfonate, oleic acid, deoxycholic acid, or combinations thereof.

37. The soap composition of any one of the preceding embodiments, wherein the polysaccharide can include chitin, cellulose, or a combination thereof.

38. The soap composition of any one of the preceding embodiments, wherein the fatty acid can include a C₈-C₂₂ fatty acid.

39. The soap composition of any one of the preceding embodiments, wherein the fatty acid can include lauric acid, palmitic acid, palmitoleic acid, stearic acid, oleic acid, linoleic acid, myristic acid, or a mixture thereof.

40. The soap composition of any one of the preceding embodiments, further comprising a fragrance.

41. The soap composition of any one of the preceding embodiments, wherein the fragrance can be in an amount from 0.1% to 2% by weight, based on the total weight of the soap composition. 42. The soap composition of any one of the preceding embodiments, wherein the soap composition can soften at a temperature of 35° C. or greater.

43. The soap composition of any one of the preceding embodiments, wherein the soap composition can soften at a temperature from 35° C. to 70° C.

44. The soap composition of any one of the preceding embodiments, wherein the soap composition can be in the form of a sheet.

45. The soap composition of any one of the preceding embodiments, wherein the soap composition can be dissolvable in water.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A soap composition comprising:
a polymer matrix comprising a first polymer,
a polysaccharide that is substantially homogenously distributed within the polymer matrix, and
a fatty acid.

2. The soap composition of claim 1, wherein the first polymer has a melting temperature of 150° C. or less.

3. The soap composition of claim 1, wherein the first polymer is selected from a polyalkylene oxide, a polyamine, a polyimine, a polyalcohol, a polyvinyl acetate, a polycarboxylic acid, a polyanhydride, cellulose, a blend thereof, or a copolymer thereof.

4. The soap composition of claim 1, wherein the first polymer is selected from polyvinyl amine, polyetheramine, polyoxyalkylene amine, polyalkyleneimine, polyethylene oxide, polypropylene oxide, polyvinyl alcohol, polyethylene-vinyl acetate copolymer, polyethylene-vinyl alcohol copolymer, polylactic acid, polylactic acid-glycolic acid copolymer, polylactic acid-succinic acid copolymer, a blend thereof, or a copolymer thereof.

5. The soap composition of claim 1, wherein the first polymer in the polymer matrix is crosslinked with a linker.

6. The soap composition of claim 1, wherein the polymer matrix is present in an amount of from 50% to 90% by weight, based on the total weight of the soap composition.

7. The soap composition of claim 1, wherein the polysaccharide comprises chitin, chitosan, cellulose, or a combination thereof.

8. The soap composition of claim 1, wherein the polysaccharide is present in an amount of from 1% to 35% by weight, based on the total weight of the soap composition.

9. The soap composition of claim 1, wherein the fatty acid comprises a C₈-C₂₂ fatty acid.

10. The soap composition of claim 1, wherein the fatty acid is present in an amount of from 1% to 10% by weight, based on the total weight of the soap composition.

11. The soap composition of claim 1, wherein the fatty acid is covalently linked to the first polymer.

12. The soap composition of claim 5, wherein the fatty acid is covalently linked to the linker in the polymer matrix.

13. The soap composition of claim 1, further comprising a surfactant.

14. The soap composition of claim 1, further comprising a fragrance.

15. The soap composition of claim 1, comprising:
a surfactant in an amount from 30% to 60% by weight, based on the total weight of the soap composition,
a polysaccharide in an amount from 1% to 35% by weight, based on the total weight of the soap composition,
a fatty acid in an amount from 1% to 10% by weight, based on the total weight of the soap composition, and
a polymer matrix in an amount from 25% to 50% by weight, based on the total weight of the soap composition.

16. The soap composition of claim 1, wherein the soap composition softens at a temperature from 35° C. to 70° C.

17. The soap composition of claim 1, wherein the soap composition is dissolvable in water.

18. A method of preparing a soap composition of claim 1, comprising blending the polymer matrix, the polysaccharide, and the fatty acid to form a substantially homogenous mixture, wherein the mixture does not include a solvent.

19. The method of claim 18, further comprising reacting a linker with the polymer matrix prior to blending with the polysaccharide and the fatty acid.

20. The method of claim 18, wherein the method comprises heating the substantially homogenous mixture at a temperature of 150° C. or less.
